(19) United States
(12) Patent Application Publication
(10) Pub. No.: US 2026/0010698 A1
(43) Pub. Date: Jan. 8, 2026

(54) DESIGN SUPPORT METHOD AND DESIGN SUPPORT DEVICE

(71) Applicant: Hitachi, Ltd., Tokyo (JP)

(72) Inventors: Zuitoku SHIN, Tokyo (JP); Isao HODA, Tokyo (JP); Jia LI, Tokyo (JP); Aya OHMAE, Tokyo (JP)

(21) Appl. No.: 18/881,772

(22) PCT Filed: May 22, 2023
(86) PCT No.: PCT/JP2023/018862

§ 371 Date: Jan. 7, 2025

(30) Foreign Application Priority Data
Aug. 8, 2022 (JP) 2022-126139

(51) Int. Cl. G06F 30/333; G06F 119/02

(52) U.S. Cl. CPC G06F 30/333; G06F 2119/02

(57) ABSTRACT

A design support device includes an input unit, a calculation unit configured to create a component model based on the component data received from the input unit and processing the component model and the design and structure data to evaluate performance of the circuit system, and an output unit. The calculation unit includes a component model generation unit configured to, when a part of data required for evaluating the performance of the circuit system is missing in the component data received from the input unit, create complementary data for complementing missing data, and configured to create the component model using the component data received from the input unit and the complementary data, so that even when information about an electronic component used in a circuit system using the electronic component is not sufficiently provided, parameters of an analysis model can be extracted to perform an analysis.

### TECHNICAL FIELD

The present invention relates to a design support method and a design support device.

### BACKGROUND ART

In fields of industry, infrastructure, and in-vehicle, as a system and a device become more electronic and electrified, it is important to operate an electronic system and a device safely and securely for a long period of time and continuously provide a value.

For example, in a product having a long life cycle such as an elevator, various types of semiconductors constituting an internal control circuit system have short life cycles, and there are many cases where the product reaches the end of life (EOL) in a short period after new installation. As a countermeasure, an EOL target component having reached the end of life among components configuring the control circuit system may be replaced with a replacement component. However, when the EOL target component is replaced with a replacement component, a verification test for the control circuit system after change is required.

In order to reduce the number of steps of the verification test, a design support method is used in which various kinds of performance of the control circuit system after change are predicted by simulation and feedback is provided by a design in advance.

For example, PTL 1 discloses a design support device that analyzes new CAD data using an analysis result of past CAD data, and the design support device includes a database that stores analysis result data for the past CAD data in association with a plurality of shape parameters and analysis conditions that constitute the past CAD data, a learning unit that learns the plurality of shape parameters and analysis conditions as training data, and an analysis processing execution determination unit that skips analysis processing for newly input CAD data when an analysis result corresponding to a shape parameter and an analysis condition that constitute the newly input CAD data is stored in the database.

### CITATION LIST

### Patent Literature

PTL 1: JP2017-111658A

### SUMMARY OF INVENTION

### Technical Problem

In a case of constructing a circuit analysis model or an electromagnetic field analysis model, when a new component is adopted or when a component is replaced with a replacement component, there is a problem that information about the component may not be sufficiently provided, and it may be difficult to model a system after change for verification test.

Even when new design data and past design data are compared to extract a difference, there is a problem that design data information about a newly adopted component may not be sufficiently provided, and it may be difficult to extract difference data.

However, PTL 1 does not consider these problems, and when information about a new component or a replacement component is not sufficiently provided, it is difficult to model a system after change for verification test.

An object of the invention is to solve the above problems in the related art, and provide a design support method and a design support device that include a component model generation unit capable of analyzing and predicting a tendency of a missing component feature value in modeling based on a past component feature value, a past measurement result, and a past analysis result, and extracting a parameter of an analysis model even when information about a newly adopted electronic component is not sufficiently provided in a circuit system using an electronic component, and the design support method and the design support device achieve an analysis design by complementing component information.

### Solution to Problem

In order to solve the above problems, the invention provides a design support device that includes an input unit configured to input design and structure data and component data of a circuit system, a calculation unit configured to create a component model based on the component data received from the input unit and process the component model and the design and structure data to evaluate performance of the circuit system, and an output unit configured to output a result of evaluating the performance of the circuit system by the calculation unit. The calculation unit includes a component model generation unit configured to, when a part of data required for evaluating the performance of the circuit system is missing in the component data received from the input unit, create complementary data for complementing the missing data, and configured to create the component model using the component data received from the input unit and the complementary data.

In order to solve the above problems, the invention provides a design support method using a design support device including an input unit, a calculation unit, and an output unit. The design support method includes inputting design and structure data and component data of a circuit system from the input unit, creating a component model by the calculation unit based on the component data received from the input unit, processing, by the calculation unit, the component model and the design and structure data to evaluate performance of the circuit system, and outputting a result of evaluating the performance of the circuit system from the output unit, in which in creating the component model by the calculation unit, when a part of data required for evaluating the performance of the circuit system is missing in the component data received from the input unit, complementary data for complementing the missing data is created, and the component model is created using the component data received from the input unit and the complementary data.

### Advantageous Effects of Invention

According to the invention, even when component information is not sufficiently provided, an analysis design can be achieved by complementing missing component information using information such as a past component feature value, a past measurement result, and a past analysis result.

### BRIEF DESCRIPTION OF DRAWINGS

FIG. 1 is a block diagram showing a configuration of an analysis support device according to Embodiment 1 of the invention.

FIG. 2 is a flowchart showing a flow of processing of an analysis support method according to Embodiment 1 of the invention.

FIG. 3 is a flowchart showing a detailed flow of processing of a component model generation step in the processing of the analysis support method according to Embodiment 1 of the invention.

FIG. 4 shows examples of past data accumulated in a past data accumulating unit that is referred to in the component model generation step, in which (a) is a graph showing an annual change tendency of ESL of a capacitor manufactured by an A company, (b) is a graph showing a data change for each generation of a switching transient feature (dv/dt) of an IGBT manufactured by a D company, and (c) is a graph showing a tendency of an annual change of a parasitic capacitance of an IGBT manufactured by a G company.

FIG. 5 is a graph showing a relationship between an impedance Z of a circuit and a drive speed in an example in which a change tendency of a parameter obtained by past analyses accumulated in the past data accumulating unit is expressed as a function.

FIG. 6 is a graph showing a result of measuring a relationship between a frequency and a passing feature of an electronic device accumulated in the past data accumulating unit.

FIG. 7 is a block diagram showing a structure model for conduction noise analysis of a power conversion device (an inverter) according to Embodiment 2 of the invention.

FIG. 8 is a table showing, in a list form, parameters required for a component model of a power module (IGBT) shown as an example of a component model used in a structure model for conduction noise analysis of the power conversion device (the inverter) according to Embodiment 2 of the invention.

FIG. 9 is a circuit diagram showing a component model of a power module (IGBT) shown as an example of a component model used in a structure model for conduction noise analysis of the power conversion device (the inverter) according to Embodiment 2 of the invention.

FIG. 10 is a table showing a list of past data of a component model of a power module (IGBT) shown as an example of past data required for analyzing a structure model for conduction noise analysis of the power conversion device (the inverter) according to Embodiment 2 of the invention.

FIG. 11 is a circuit block diagram showing component models for conduction noise analysis of the power conversion device (the inverter) according to Embodiment 2 of the invention, in which (a) is a circuit block diagram showing a line impedance stabilization network (LISN), (b) is a circuit block diagram showing a Y capacitor, (c) is a circuit block diagram showing a power module (IGBT), and (d) is a circuit block diagram showing a load.

FIG. 12 is a circuit block diagram showing an analysis model for conduction noise analysis of the power conversion device (the inverter) according to Embodiment 2 of the invention.

FIG. 13 is a graph showing a frequency feature of a conduction noise voltage output as a conduction noise analysis result of the power conversion device (the inverter) according to Embodiment 2 of the invention, and shows a state where the conduction noise voltage is equal to or lower than an allowable voltage value in a range of a measured frequency.

FIG. 14 is a block diagram showing a configuration of an analysis support device according to Embodiment 3 of the invention.

FIG. 15 is a flowchart showing a flow of processing of an analysis support method according to Embodiment 3 of the invention.

FIG. 16 is a graph showing a frequency feature of a conduction noise voltage output as a conduction noise analysis result of a power conversion device (an inverter) according to the Embodiment 3 of the invention, and shows a state where the conduction noise voltage exceeds an allowable voltage value in a range of a certain frequency.

FIG. 17 is a circuit block diagram of a Y capacitor showing a case where the Y capacitor is replaced as an example of a case where a component is replaced when a feature of a conduction noise voltage does not satisfy a target specification as a conduction noise analysis result of the power conversion device (the inverter) according to Embodiment 3 of the invention.

### DESCRIPTION OF EMBODIMENTS

The invention relates to an analysis support method and device that have a component model generation unit capable of analyzing and predicting a tendency of a missing component feature value in modeling based on a past component feature value, a past measurement result, and a past analysis result, and extracting a parameter of an analysis model, and that achieve an analysis design by complementing component information.

In addition, the invention relates to an analysis support method and device in which a change tendency is predicted using past data and a parameter is complemented for a parameter that cannot be extracted from current component data and design data or for which information is not disclosed, among components and structure parameters required for analysis.

Specifically, the design support method and device determine whether modeling is possible based on a data sheet of an electronic component in a circuit system using an electronic component, and when information is missing, missing information is specified by a missing information specifying unit. The design support method and device include a feature tendency prediction unit that predicts a tendency of a component feature value based on past data, and a component parameter extraction unit that extracts a component parameter from a predicted component feature. The design support method and device predict various kinds of performance by providing parameters required for an analysis model.

In addition, according to the invention, the design support method and device determine whether modeling is possible based on component data sheet, and when information is not missing, missing information is determined by the missing information specifying unit. The design support method and device include a feature tendency prediction unit that predicts a tendency of a component feature value based on past data, and a component parameter extraction unit that extracts a component parameter from a predicted component feature. The design support method and device predict various kinds of performance by providing parameters required for an analysis model.

Hereinafter, embodiments of the invention will be described in detail with reference to the drawings. In all drawings for illustrating the embodiments, components having the same functions are denoted by the same reference signs, and repeated description thereof is omitted in principle.

The invention is not to be construed as being limited to the description of the embodiments to be described below. It will be easily understood by those skilled in the art that a specific configuration can be changed without departing from the spirit or scope of the invention.

### Embodiment 1

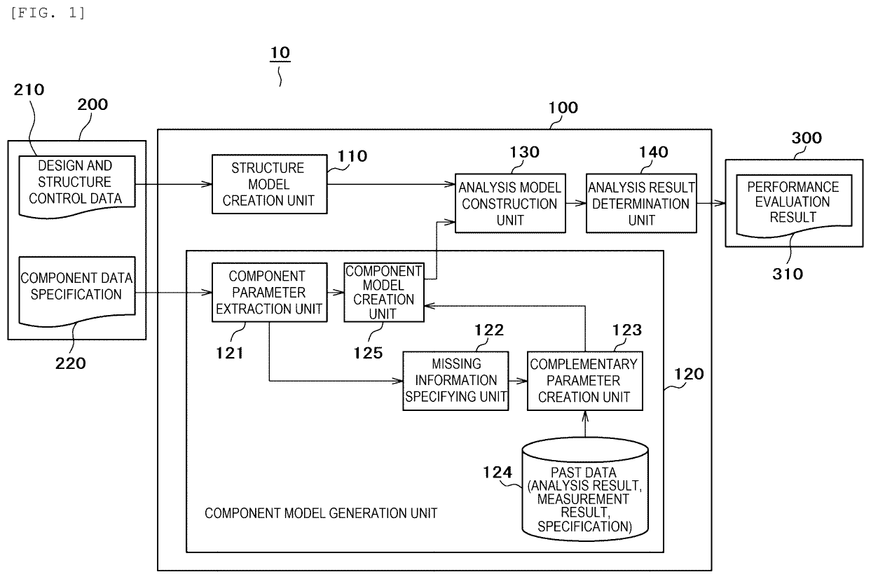

Hereinafter, a first embodiment of the invention will be described with reference to FIGS. 1 to 4.

A design support device 10 according to the present embodiment includes a data input unit 200, a calculation unit 100, and an output unit 300. The calculation unit 100 includes a structure model creation unit 110 that creates a structure model by inputting, from the data input unit 200, design and structure control data 210 of a circuit system using an electronic component, a component model generation unit 120 that creates a component model by inputting, from the data input unit 200, data of a component data specification 220 of each component constituting the circuit system using an electronic component, an analysis model construction unit 130 that constructs an analysis model by inputting the structure model created by the structure model creation unit 110 and the component model created by the component model generation unit 120, and an analysis result determination unit 140 that analyzes the analysis model constructed by the analysis model construction unit 130 to determine performance. The output unit 300 outputs a performance evaluation result 310 determined by the analysis result determination unit 140.

Here, the design support device 10 is implemented by, for example, a computer. An example of the data input unit 200 is a user interface device such as a mouse or a touch panel. An example of the calculation unit 100 is a processor such as a CPU or a GPU. An example of the output unit 300 is a display device. The data input unit 200 and the output unit 300 may be implemented by causing a processor to execute a program such as a device driver of an operating system. In addition, the data input unit 200 may be implemented by using a program and a user interface device in combination. Similarly, the output unit 300 may be implemented by using a program and a display device in combination. The design support device may include a volatile memory (not shown) or a nonvolatile memory (not shown) (the volatile memory and the nonvolatile memory are collectively referred to as a memory). The memory stores an operating system.

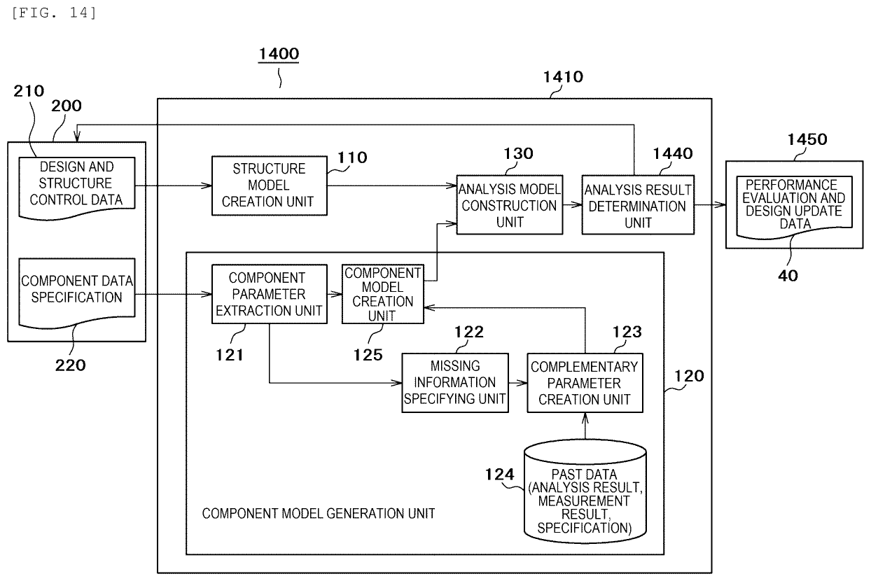

Each unit (for example, the component model generation unit 120) shown in FIG. 1 (and FIG. 14) in a form of being included in the calculation unit 100 may be implemented by a processor executing a design support program stored in the memory. Although data including past data such as an analysis result, a measurement result, and a specification may be shown in a format of being included in the calculation unit 100 in FIG. 1 and FIG. 14, the data may actually be stored in a memory. The calculation unit 100 may be implemented by a processor, a memory, or a program stored in a memory.

The above implementation example of such a design support device may be applied to embodiments other than Embodiment 1.

The component model generation unit 120 further includes a component parameter extraction unit 121, a missing information specifying unit 122, a complementary parameter creation unit 123, a past data accumulating unit 124, and a component model creation unit 125.

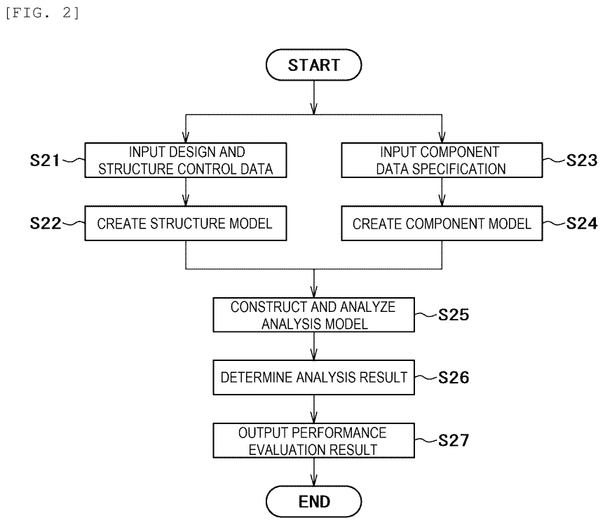

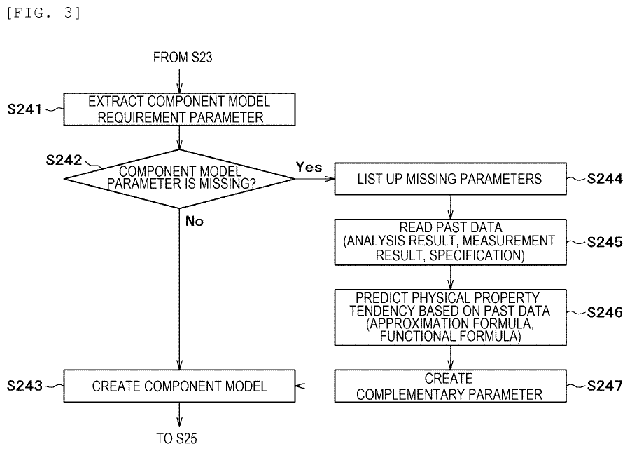

A flow of processing of inputting the design and structure control data 210 and the component data specification 220 from the data input unit 200 to the calculation unit 100 and outputting the performance evaluation result 310 to the output unit 300 using the design support device 10 shown in FIG. 1 will be described with reference to FIG. 2 and FIG. 3.

FIG. 2 shows a flow of the entire processing, and FIG. 3 shows details of processing executed by the component model generation unit 120 in the processing flow in FIG. 2.

In FIG. 2, first, the design and structure control data 210 is input from the data input unit 200 to the structure model creation unit 110 of the calculation unit 100 (S21), and a structure model is created by the structure model creation unit 110 (S22). On the other hand, the component data specification 220 is input from the data input unit 200 to the component model generation unit 120 of the calculation unit 100 (S23), and a component model is created by the component model generation unit 120 (S24).

Next, the structure model created by the structure model creation unit 110 and the component model created by the component model generation unit 120 are input to the analysis model construction unit 130 to construct an analysis model (S25). The analysis model constructed by the analysis model construction unit 130 is sent to and analyzed by the analysis result determination unit 140, and performance of a circuit system using an electronic component is determined (S26). A determination result is sent to the output unit 300 and output as the performance evaluation result 310 (S27).

In the processing flow described with reference to FIG. 2, in a case where a replacement component is used when a regular component fails or when periodic component replacement is performed, if data related to the replacement component is missing in the component data specification 220 input to the component model generation unit 120 in S23, it is required to perform processing for complementing missing data in order to create the component model in S24. A detailed processing flow in S24 including such a processing flow will be described with reference to FIG. 3.

In a flowchart shown in FIG. 3, first, a parameter required for generating a component model is extracted by the component parameter extraction unit 121 from the component data specification 220 input in S23 (S241). Next, it is checked whether all parameters required for generating the component model are all parameters extracted in S241 or whether there is a missing parameter (S242). When it is determined that all parameters required for generating the component model are extracted by the component parameter extraction unit 121 and there is no missing parameter (No in S242), the extracted component parameters are used as a component model (S243), the component model is output to the analysis model construction unit 130, and the processing proceeds to step (S25).

On the other hand, when it is determined in S242 that there is a missing parameter in the parameters required for generating the component model extracted by the component parameter extraction unit 121 (Yes in S242), information about the missing parameter is sent to the missing information specifying unit 122 to list up missing parameters (S244).

Information about the listed-up missing parameters is sent to the complementary parameter creation unit 123, and the complementary parameter creation unit 123 reads past data such as an analysis result, a measurement result, and a specification stored and accumulated in the past data accumulating unit 124 (S245). An approximation formula, a functional formula, and the like are created based on the read past data to predict a physical property tendency of a replacement component for which a parameter is missing (S246).

Next, the complementary parameter creation unit 123 creates a complementary parameter for complementing the missing parameter by using information about the predicted physical property tendency of the replacement component for which a parameter is missing, which is predicted in S246 (S247).

Information about the complementary parameter created in step S247 is sent to the component model creation unit 125, and is processed together with a component model requirement parameter extracted by the component parameter extraction unit 121 in S241 to create a component model (S243). The information is output to the analysis model construction unit 130, and the processing proceeds to step (S25) described with reference to FIG. 2.

In this manner, in a case where a regular component is replaced with a replacement component, even when a part of parameter information required for generating a component model the same as that of the regular component is missing for the replacement component, it is possible to analyze performance after the regular component is replaced with the replacement component by providing the design support device with a function of complementing a missing parameter based on accumulated past data.

When missing information in the input component data specification 220 is specified by the missing information specifying unit 122, the complementary parameter creation unit 123 obtains an approximate expression based on data stored and accumulated in the past data accumulating unit 124, for example, based on an annual tendency of past actual measured data and a change tendency of product generations, and predicts a required parameter value.

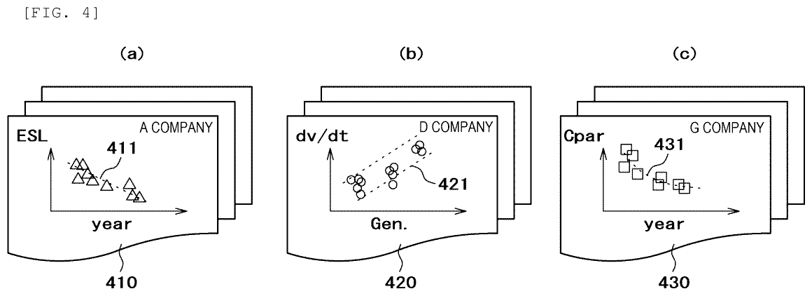

As an example of the data accumulated in the past data accumulating unit 124 of the component model generation unit 120 in FIG. 1, (a) of FIG. 4 shows a graph 410 indicating an annual change tendency of, for example, an equivalent series inductance (ESL) of a capacitor manufactured by an A company as a feature of an electronic component used in a circuit board of an electronic device. When an ESL value of the capacitor manufactured by the A company is specified as missing information by the missing information specifying unit 122, the complementary parameter creation unit 123 obtains an approximate curve 411 based on the graph 410, calculates a predicted value of the ESL of the capacitor manufactured by the company A, creates a storage parameter, and sends a result to the component model creation unit 125. Accordingly, the ESL value of the capacitor manufactured by the A company that is used as a replacement component, which is not obtained from the component data specification 220, is complemented to information extracted by the component parameter extraction unit 121, which enables the component model creation unit 125 to create a component model.

(b) of FIG. 4 shows a graph 420 indicating an example of a data change for each generation of a switching transient feature (dv/dt) of an integrated gate bipolar transistor (IGBT) manufactured by a D Company as an example of data accumulated in the past data accumulating unit 124. When the switching transient feature (dv/dt) of the IGBT manufactured by the D company is specified as missing information by the missing information specifying unit 122, the complementary parameter creation unit 123 obtains an approximate curve 421 based on the graph 420, calculates a predicted value of the target switching transient feature (dv/dt) of the IGBT manufactured by the D company, and sends a result to the component model creation unit 125. Accordingly, the value of the switching transient feature (dv/dt) of the IGBT manufactured by the D company that is used as a replacement component, which is not obtained from the component data specification 220, is complemented to information extracted by the component parameter extraction unit 121, which enables the component model creation unit 125 to create a component model.

(c) of FIG. 4 shows a graph 430 indicating an example of an annual change tendency of values of a parasitic capacitance (Cpar) of an IGBT manufactured by a G company as an example of data accumulated in the past data accumulating unit 124. Cpar data is not included in a device specification because the Cpar data is affected by a relationship between the IGBT and a surrounding circuit, and is basically determined by a device user through measurement and is registered in the complementary parameter creation unit 123 as data such as data shown in (c) of FIG. 4. When a Cpar value of the IGBT manufactured by the G company is specified as missing information by the missing information specifying unit 122, the complementary parameter creation unit 123 obtains an approximate curve 431 based on the graph 430, calculates a predicted Cpar value for a target IGBT manufactured by the G company, and sends a result to the component model creation unit 125. Accordingly, the Cpar value of the IGBT manufactured by the G company that is used as a replacement component, which is not obtained from the component data specification 220, is complemented, which enables the component model creation unit 125 to create a component model.

In the examples described with reference to (a) to (c) of FIG. 4, an obtained parameter value may be one point or a value having a width.

As data accumulated in the past data accumulating unit 124, in addition to the data described with reference to (a) to (c) of FIG. 4, a function expressing a change tendency of a parameter obtained in a past analysis may be set, a condition may be set according to an analysis to be performed, and a value may be predicted. There are cases where it is also necessary to consider a case where parameters have correlation with each other due to a trade-off relationship or the like.

FIG. 5 shows an example of a function expressing a change tendency of parameters obtained in past analyses accumulated in the past data accumulating unit 124, in which a relationship 511 between an impedance Z of a circuit and a drive speed is obtained and graphed as in a graph 510. In a case where the impedance of the circuit in a drive range is specified as missing information by the missing information specifying unit 122, the complementary parameter creation unit 123 obtains data in a change range of the impedance Z in a drive range 512 specified based on the graph 510, and sends a result to the component parameter extraction unit 121, so that the data in the change range of the impedance Z in the specified drive range 512, which is not obtained from the component data specification 220, can be complemented, and thus the component parameter extraction unit 121 can create a component model.

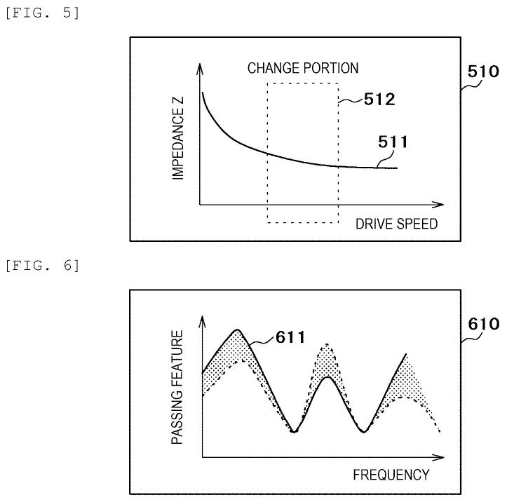

FIG. 6 shows a case where information having a width is obtained by the complementary parameter creation unit 123 for feature variation 611 in a graph 610 of actual measured data obtained by measuring a relationship between a frequency and a passing feature of an electronic device based on data accumulated in the past data accumulating unit 124.

According to the present embodiment, it is determined whether modeling is possible based on a component data sheet, when information is missing, the missing information is specified by the missing information specifying unit, information corresponding to the missing information is predicted by a feature tendency prediction unit based on past data, and a component model is created by complementing the missing information with the predicted information. Therefore, even when a part of information required for modeling is missing in the component data sheet, a parameter required for an analysis model can be complemented, and accordingly missing component information can be complemented and an analysis design can be achieved.

### Embodiment 2

Next, an example in which the design support device 10 described in Embodiment 1 is pinched in a conduction noise analysis model of a power conversion device (an inverter) will be described in Embodiment 2.

First, corresponding to S21 in the flowchart shown in FIG. 2 described in Embodiment 1, data of the conduction noise analysis model of the power conversion device (the inverter) is input from the data input unit 200 shown in FIG. 1 as the design and structure control data 210.

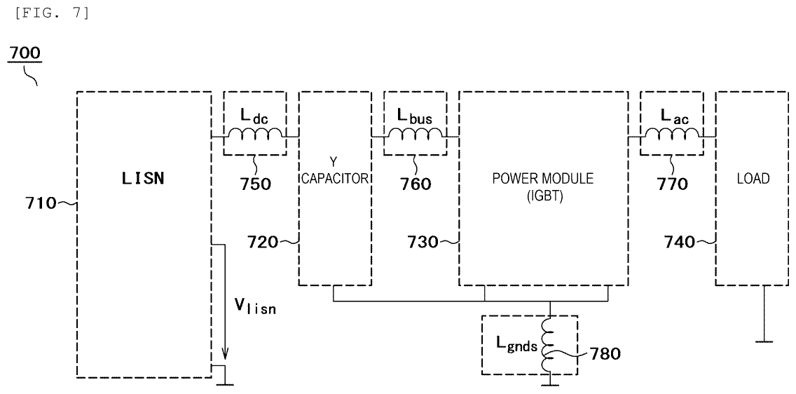

Next, corresponding to S22, the structure model creation unit 110 of the calculation unit 100 creates a structure model 700 for conduction noise analysis of the power conversion device as a structure model created by extracting a required parameter, as shown in FIG. 7, the structure model 700 includes a line impedance stabilization network (LISN) 710, a Y capacitor 720, an IGBT 730 serving as a power module, and a load 740, which are connected to each other by a DC cable 750, a bus bar 760, and an AC cable 770, and the Y capacitor 720 and the IGBT 730 are connected to ground by a ground strap 780.

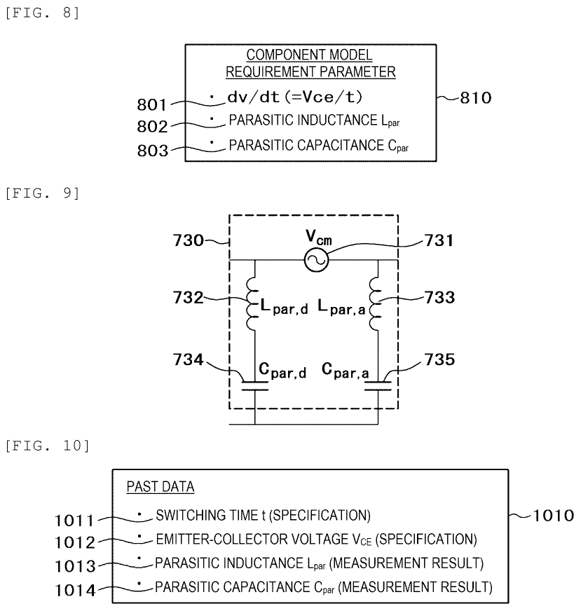

On the other hand, corresponding to S23 in the flowchart shown in FIG. 2, information about the component data specification 220 is input from the data input unit 200 shown in FIG. 1 to the component model generation unit 120. For example, in a case where a target component is the IGBT 703, the information about the component data specification 220 input to the component model generation unit 120 includes component parameters such as dv/dt (a switching transient feature) 801, a parasitic inductance Lpar: 802, and a parasitic capacitance Cpar: 803, as shown in a component model requirement parameter 810 in FIG. 8.

Next, corresponding to S24, the component model generation unit 120 that receives the information about the component data specification 220 creates a component model.

FIG. 9 shows a case of creating a configuration of the IGBT 730 in the structure model 700 for conduction noise analysis of the power conversion device shown in FIG. 7 as an example of a component model, in which parasitic inductances Lpar, d: 732 and Lpar, a: 733 and parasitic capacitances Cpar, d: 734, and Cpar, a: 735 are provided before and after a noise source model Vcm: 731 reflecting dv/dt: 801.

Here, in the flowchart shown in FIG. 3 showing detailed steps of S24, when the component parameter extraction unit 121 of the component model generation unit 120 determines in step S242 that there is missing data in a component model parameter to be extracted for the component model requirement parameter extracted in step S241, the missing information specifying unit 122 lists up missing component model parameters in step S244.

Next, corresponding to S245, the complementary parameter creation unit 123 creates a missing parameter.

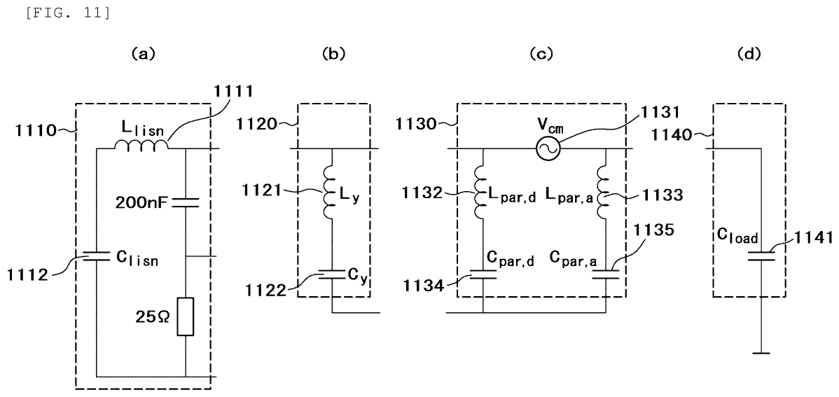

For example, when the missing parameter is the dv/dt: 801 of the IGBT 730, it is possible to roughly estimate the missing parameter based on past data of each component accumulated in the past data accumulating unit 124 as shown in FIG. 10, that is, based on a switching time t: 1011 and a collector-emitter voltage V_{CE}: 10122 in a past component specification.

Since a required withstand voltage value of the collector-emitter voltage V_{CE}: 10122 is different depending on an application of the IGBT 730, for an IGBT that satisfies a condition such as a required withstand voltage value and a maximum Ic, it is possible to predict another parameter such as the switching time t: 1011 as the switching time t: 1011 of a next generation product serving as a physical property tendency based on past data related to the switching times t of a plurality of IGBTs of the same type stored and accumulated in the past data accumulating unit 124.

However, when the missing parameter is the parasitic inductance Lpar: 802 or the parasitic capacitance Cpar: 803 shown in FIG. 8, there are many cases where there is no description in the specification, and therefore, a physical property tendency is predicted based on past measurement data of a parasitic inductance Lpar: 1013 and a parasitic capacitance Cpar: 1014 accumulated in the past data accumulating unit 124 as described with reference to FIGS. 4 and 5 in Embodiment 1.

For the LISN 710, the Y capacitor 720, and the load 740, a component model can be created by processing the same as that of the above-described IGBT 730.

That is, when the component parameter extraction unit 121 determines that there is missing information in the component model parameter in the component data specification 220 of the LISN 710, the Y capacitor 720, or the load 740 received from the data input unit 200, the missing information specifying unit 122 specifies the missing information, and the complementary parameter creation unit 123 creates a missing component model parameter by using related past data accumulated in the past data accumulating unit 124, and the component model creation unit 125 creates a component model of the LISN 710, the Y capacitor 720, or the load 740.

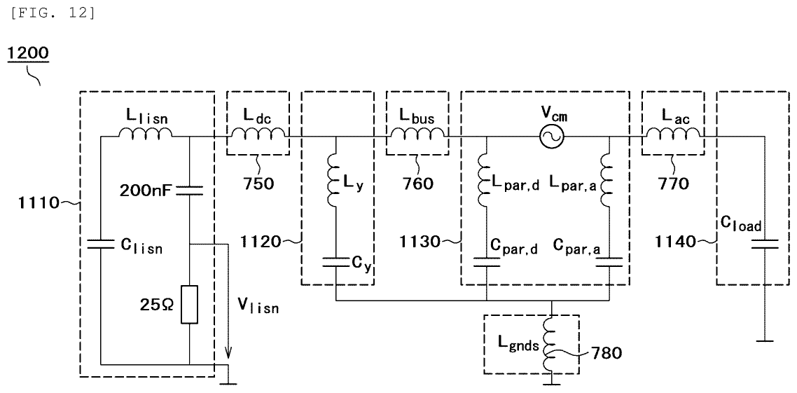

FIG. 11 shows component models created in such a manner in a step corresponding to S24 in FIG. 2, in which (a) shows a component model 1110 of the LISN 710 having a configuration including an inductance Lisn: 1111 and a capacitance 1112, (b) shows a component model of the Y capacitor 720 having a configuration including an inductance Ly: 1121 and a capacitance Cy: 1122, (c) shows a component model 1130 of the IGBT 730 having a configuration including a noise source model Vcm: 1131, parasitic inductances Lpar, d: 1132 and Lpar, a: 1133, and parasitic capacitances Cpar, d: 1134 and Cpar, a: 1135, and (d) shows a component model 1140 of the load 740 having a configuration including a capacitance Cload: 1141.

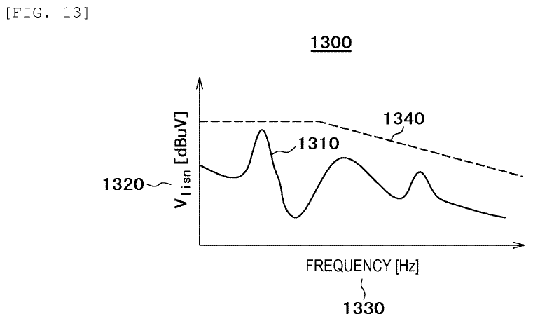

Next, corresponding to step S25 shown in FIG. 2, the analysis model construction unit 130 shown in FIG. 1 constructs a conduction noise analysis model of the power conversion device (the inverter) and analyzes conduction noises. FIG. 12 shows a configuration of a conduction noise analysis model 1200 of the power conversion device (the inverter) created in the present embodiment.

The conduction noise analysis model 1200 of the power conversion device (the inverter) is constructed by the analysis model construction unit 130 by combining the component models 1110, 1120, 1130, and 1140 shown in (a) to (d) of FIG. 11 created by the component model generation unit 120 with the DC cable 750, the bus bar 760, the AC cable 770, and the ground strap 780 in the structure model described with reference to FIG. 7 and created by the structure model creation unit 110.

The conduction noise analysis is executed by the analysis result determination unit 140 using the conduction noise analysis model 1200 of the power conversion device (the inverter) constructed in such a manner (S25). The performance is determined as to whether an analysis result of a conduction noise voltage satisfies a noise allowable value (S26), and a determination result is outputted from the output unit 300 as the performance evaluation result 310 (S27).

FIG. 13 shows an example of the performance evaluation result 310 output from the output unit 300, which is indicated by a graph 1300 showing a relationship between a voltage Vlisn: 1320 of a conduction noise amount (a conduction noise voltage) 1310 and a frequency 1330, and a relationship between the voltage Vlisn: 1320 of the conduction noise amount (a conduction noise voltage) 1310 and a noise allowable value 1340. FIG. 13 shows a state where the conduction noise amount (the conduction noise voltage) 1310 is smaller than the noise allowable value 1340 in a predetermined range of the frequency 1330 and conduction noises of the power conversion device (the inverter) satisfies predetermined performance.

According to the present embodiment, in a case where the conduction noise analysis of the power conversion device (the inverter) is executed, even when information for modeling is missing in the component data, information corresponding to the missing information can be predicted based on past data, and a component model can be created by complementing the missing information with the predicted information, and thus it is possible to complement missing component information and execute the conduction noise analysis of the power conversion device (the inverter).

### Embodiment 3

A third embodiment of the invention will be described with reference to FIGS. 14 to 17. The same components as those of Embodiments 1 and 2 are denoted by the same reference numerals, and description thereof is omitted.

A design support device 1400 according to the present embodiment shown in FIG. 14 is different in that the calculation unit 100 of the design support device 10 according to Embodiment 1 is replaced with a calculation unit 1410, and the output unit 300 in Embodiment 1 is replaced with an output unit 1430. In the calculation unit 1410, the analysis result determination unit 140 in Embodiment 1 is replaced with an analysis result determination unit 1440. The configuration and the function of the component model generation unit 120 are the same as those in Embodiment 1, and description thereof is omitted.

In Embodiment 1, the analysis model constructed by the analysis model construction unit 130 is analyzed by the analysis result determination unit 140 to determine performance, and a result is output from the output unit 300, whereas in the present embodiment, when it is determined that a result obtained by determining performance by the analysis result determination unit 1440 analyzing the analysis model constructed by the analysis model construction unit 130 does not satisfy predetermined performance, processing of updating the design and structure control data 210 and the component data specification 220 that are received from the data input unit 200 to the calculation unit 1410 and constructing and evaluating an analysis model again by the analysis model construction unit 130 is repeated until it is determined that an analysis result of the analysis model satisfies the predetermined performance, and the output unit 1450 outputs a finally obtained performance evaluation result and corresponding updated design and structure control data as performance evaluation and design update data 40.

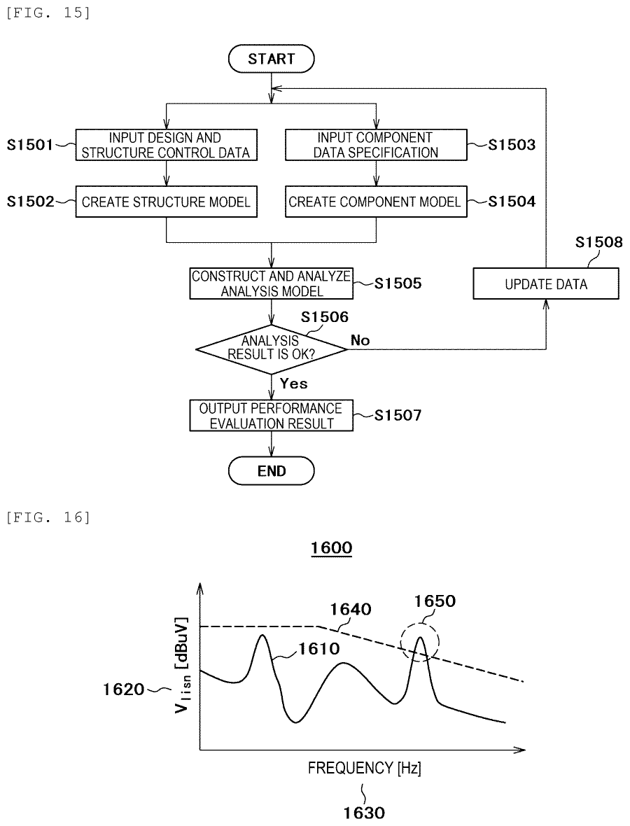

FIG. 15 shows a processing flow according to the present embodiment. In FIG. 15, steps S1501 to S1505 are the same as steps S21 to S25 of the processing described with reference to FIG. 2 in Embodiment 1.

In S1506, the analysis model constructed by the analysis model construction unit 130 is analyzed by the analysis result determination unit 140 and it is determined whether an analysis result satisfies predetermined performance.

When it is determined that the analysis result does not satisfy the predetermined performance (No in S1506), the design and structure control data and corresponding data of the component data specification 220 in the data input unit 200 are updated based on a predetermined condition (S1508). The processing returns to S1501, the updated design and structure control data is input again to the structure model creation unit 110, and the processing returns to S1503, the updated data of the component data specification 220 is input again to the component model generation unit 120, and processing in steps S1502, S1504 and subsequent steps is repeated until a determination result in S1506 is Yes.

On the other hand, when it is determined that the analysis result satisfies the predetermined performance (Yes in S1506), a determination result is sent to the output unit 1450 and output as the performance evaluation and design update data 40 in a performance evaluation result output step (S1507).

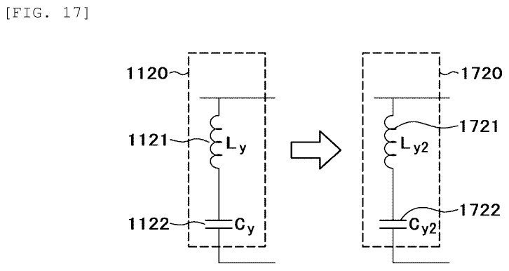

FIG. 16 shows an example of a case where it is determined that the analysis result does not satisfy the predetermined performance (No in S1506) when an analysis target is conduction noises of a power conversion device (an inverter) the same as that described in Embodiment 2.

Similar to Embodiment 2, FIG. 16 shows a graph 1600 showing a relationship between a voltage Vlisn: 1620 of a conduction noise amount (a conduction noise voltage) 1610 and a frequency 1630, and a relationship between the voltage Vlisn: 1620 of the conduction noise amount (the conduction noise voltage) 1610 and a noise allowable value 1640, as a result of a conduction noise analysis executed by the analysis result determination unit 1440 using the conduction noise analysis model 1200 of the power conversion device (the inverter) constructed by the analysis model construction unit 130.

FIG. 16 shows a state where the conduction noise amount (the conduction noise voltage) 1610 exceeds the noise allowable value 1640 in a region 1659 in a predetermined range of the frequency 1630, and conduction noises of the power conversion device (the inverter) do not satisfy the predetermined performance.

When a result is obtained that the analysis result of the conduction noise voltage Vlisn does not satisfy the noise allowable value 1640, the design and structure control data 210 and the component data specification 220 received from the data input unit 200 are updated, and processing from S1510 and S1503 is repeated.

For example, when the Y capacitor 720 used for noise removal is changed, as shown in FIG. 17, the component model 1120 of the Y capacitor 720 having the inductance Ly: 1121 and the capacitance Cy: 1122 recorded in the component data specification sheet 220 used in a first analysis is updated to a new component model 1720 having an inductance Ly₂: 1721 and a capacitance Cy₂: 1722 recorded in the same component data specification 220, and the processing from S1510 and S1503 is repeated. The processing from S1510 and S1503 is repeated until the analysis result of the conduction noise voltage Vlisn satisfies the noise allowable value 1640, so that it is possible to reliably select a replacement component that guarantees specified performance in terms of conduction noises of the power conversion device (the inverter).

According to the present embodiment, in addition to effects described in Embodiment 1, even when a replacement component is used, it is possible to reliably select a replacement component that guarantees predetermined performance in a circuit system using an electronic component.

Although the invention made by the present inventors has been specifically described based on the embodiments, the invention is not limited to the embodiments, and it is needless to say that various modifications can be made without departing from the gist of the invention. For example, the embodiments described above have been described in detail to facilitate understanding of the invention, and the invention is not necessarily limited to those including all the configurations described above. A part of a configuration of each embodiment may be added to, deleted from, or replaced with another configuration.

### Reference Signs List

10, 1400: design support device
100, 1410: calculation unit
110: structure model creation unit
120: component model generation unit
121: component parameter extraction unit
122: missing information specifying unit
123: complementary parameter creation unit
124: past data accumulating unit
125: component model creation unit
130: analysis model construction unit
140, 1440: analysis result determination unit
200: data input unit
300, 1450: output unit

1. A design support device comprising:
an input unit configured to input design and structure data and component data of a circuit system;
a calculation unit configured to create a component model based on the component data received from the input unit and process the component model and the design and structure data to evaluate performance of the circuit system; and
an output unit configured to output a result of evaluating the performance of the circuit system by the calculation unit, wherein
the calculation unit includes a component model generation unit configured to, when a part of data required for evaluating the performance of the circuit system is missing in the component data received from the input unit, create complementary data for complementing the missing data, and configured to create the component model using the component data received from the input unit and the complementary data.

2. The design support device according to claim 1, wherein
the component model generation unit includes
a missing information specifying unit configured to specify the missing data that is missing in the component data received from the input unit among the data required for evaluating the performance of the circuit system in the component data,
a storage unit configured to accumulate past data related to the circuit system,
a complementary parameter creation unit configured to create, using the past data stored in the storage unit, complementary data corresponding to the missing data specified by the missing information specifying unit, and
a component parameter extraction unit configured to create the component model using the component data received from the input unit and the complementary data created by the complementary parameter creation unit.

3. The design support device according to claim 2, wherein
the complementary parameter creation unit predicts, based on the past data stored in the storage unit, a physical property corresponding to the missing data specified by the missing information specifying unit, and creates the complementary data based on the predicted physical property tendency.

4. The design support device according to claim 1, wherein
when the calculation unit determines that the performance of the circuit system does not reach predetermined performance as a result of processing the component model and the design and structure data received from the input unit to evaluate the performance of the circuit system, the calculation unit updates the design and structure data and the component data of the circuit system that are received from the input unit.

5. A design support method using a design support device including an input unit, a calculation unit, and an output unit, the design support method comprising:
inputting design and structure data and component data of a circuit system from the input unit;
creating a component model by the calculation unit based on the component data received from the input unit;
processing, by the calculation unit, the component model and the design and structure data to evaluate performance of the circuit system; and
outputting a result of evaluating the performance of the circuit system from the output unit, wherein
in creating the component model by the calculation unit, when a part of data required for evaluating the performance of the circuit system is missing in the component data received from the input unit, complementary data for complementing the missing data is created, and the component model is created using the component data received from the input unit and the complementary data.

6. The design support method according to claim 5, wherein
the component model is created by
specifying the missing data that is missing in the component data received from the input unit among the data required for evaluating the performance of the circuit system in the component data,
creating the complementary data corresponding to the specified missing data by using the past data stored in a storage unit accumulating past data related to the circuit system, and
creating the component model using the component data received from the input unit and the complementary data.

7. The design support method according to claim 6, wherein
the complementary data is created by predicting a physical property tendency corresponding to the specified missing data based on the past data stored in the storage unit, and creating the complementary data based on the predicted physical property tendency.

8. The design support method according to claim 5, wherein
when it is determined that the performance of the circuit system does not reach predetermined performance as a result of processing the component model and the design and structure data received from the input unit to evaluate the performance of the circuit system in the calculation unit, the design and structure data and the component data of the circuit system that are received from the input unit are updated.
